(19) United States
(12) Patent Application Publication
(10) Pub. No.: US 2012/0074761 A1
(43) Pub. Date: Mar. 29, 2012

(54) Wheel for a vehicle operable by muscular force and in particular for a bicycle with an auxiliary motor

(76) Inventors: Martin Walthert, Aarberg (CH); Dominic Maurer, Breitenbach (CH)

(21) Appl. No.: 12/960,825

(22) Filed: Dec. 6, 2010

(30) Foreign Application Priority Data
Apr. 12, 2009 (DE) 10 2009 056 739.9

(51) Int. Cl. B60K 7/00; B60B 1/04; B60B 1/02

(52) U.S. Cl. 301/6.5

(57) ABSTRACT

Wheel for a vehicle operable by muscular force and in particular for a bicycle with an auxiliary motor and with a hub comprising a hub axle and a hub body rotatably supported relative to the hub axle. Furthermore the wheel comprises a rim with a rim base and a rim well and rim flanks. The rim is connected with the hub through a plurality of spoke devices. Each of the spoke devices comprises one spoke nipple and one spoke. The rim base is provided with passage openings through which the spoke devices extend into the rim. The hub is provided with an electric drive as an auxiliary motor and a ratio of the outer diameter of the hub to the outer diameter of the rim is higher than 1:5. The clear inner diameter of a passage opening is at least 50% larger than an outer diameter of the spoke device at the passage opening.

The invention relates to a wheel for a vehicle operable by muscular force, e.g. for a bicycle with an auxiliary motor. The invention in particular relates to a wheel having a hub drive for an E-bike, i.e. a bicycle having an auxiliary electric drive, allowing the user to travel distances while employing no muscular force for all or part of the distance traveled using the electric drive. Advantageously the wheel according to the invention is provided for a sporty bicycle wherein the auxiliary drive is employed only in segments and/or as assistance.

In the field of bicycle technology bicycles with an auxiliary electric drive have become known for everyday use allowing the user to additionally engage the auxiliary drive for the whole or specific segments of the route so as to make the ride more comfortable or less strenuous.

These days, even highly sporty bicycles tend to be employed not only in practice rides but they may be used e.g. for riding to work.

Lightweight, high-quality bicycles allow the user to travel considerable distances to work on a regular basis. An auxiliary electric drive facilitates, in particular on the final kilometers, reducing the physical exertions to the rider such that the user will be relaxed when arriving at his destination and not covered in sweat.

Another advantage of an auxiliary electric drive is that the auxiliary drive may be additionally engaged on steep inclines such that the maximum strain on the rider decreases. All of this provides the user with a larger operational range both in practice rides and in rides to work or the like which results in more frequent use of the bicycle.

Where E-bikes are concerned, electric drives may be installed in a bicycle hub. These hubs are considerably larger in their external diameters than conventional hubs of bicycles since they must accommodate the electric drive. Since at the same time the outer diameter of the wheels has specified standard dimensions, this results in an intersecting angle or angle of exit of the spoke at the spoke hole in the rim that is considerably larger than is usual in the prior art.

Although rim eyelets with ball-cup shaped contact seats tend to be employed for the spoke nipples with ball-shaped contact zones so as to allow a slightly angular orientation of the spoke relative to the spoke hole, it has been found that due to the high spoke tension the spoke nipples get orientated nearly perpendicular to the rim such that the spoke contour has a buckled portion immediately at the exit from the spoke nipple.

These buckled portions lead to a considerably increased risk of spoke breakage. In the case of inexpensive bicycles in a price range that is highly competitive where the pressure on prices is high, higher-thickness spoke materials may offset the risk of breakage. Thicker spokes, however, increase the total weight which is undesirable in high-quality bicycles. Furthermore the inertia mass increases considerably which results in poorer riding qualities.

It is therefore the object of the present invention to provide a wheel which is suitable for an electric drive and which reliably prevents the spokes from buckling even in the case of spokes crossing one another.

This object is solved by a wheel having the features of claim 1. Preferred specific embodiments of the invention are the subjects of the subclaims. Further advantages and features of the invention can be taken from the embodiment.

The wheel according to the invention for a vehicle operable at least in part by muscular force and in particular for a bicycle comprises an auxiliary motor and a hub including a hub axle and a hub body rotatably supported relative to the hub axle. Furthermore the wheel is provided with a rim comprising a rim base and a rim well, and lateral rim flanks. The rim is connected with the hub through a plurality of spoke devices. At least one spoke device and in particular each of the spoke devices comprises at least one spoke nipple and at least one spoke. The rim base according to the invention is provided with passage openings through which the spoke devices extend into the rim. An electric drive is provided at the hub as an auxiliary motor. A ratio of the outer diameter of the hub to the outer diameter of the rim is higher than 1:5. The clear inner diameter of a passage opening in the rim base is at least 50% larger than an outer diameter of the spoke device at the passage opening.

The wheel according to the invention has many advantages. A considerable advantage of the inventive wheel consists in that the wheel is suitable to be used with an electric drive. The large-dimensioned passage openings allow at the same time a considerably larger spoke angle of the crossing spokes without involving the risk of the spokes buckling.

Preferably at least some of the spokes are mounted so as to cross one another.

Preferably the spoke nipples are disposed at the rim. They are in particular provided within the hollow portion of the rim. It is conceivable for the spokes to comprise at one end a thread for screwing onto the spoke nipple and at the other end, a curved hook portion with which for example to hook the spokes into the hub. Or else it is conceivable for the spokes to comprise spoke nipples at both of their ends, one of the spoke nipples being attached to the rim and another of the spoke nipples, to the hub. It is also possible for the spokes to be deflected at the hub such that the rim is provided with a pair of spoke nipples for each spoke both of which are attached to the rim while the spoke is reversed once at the hub. Also, the spoke may be screwed into the hub.

In preferred embodiments the spoke extends through the passage hole. The spoke diameter is in particular 1.8 or 2 mm while the diameter of the passage opening is approximately 4 to 5 mm in particular approximately 4.5 mm. In a specific case with a passage opening of 4.5 mm and a spoke diameter the ratio of the diameter of the passage opening to the spoke diameter is 2.25. In this case the passage opening is 125% larger than the outer spoke diameter.

A ratio of the outer diameter of the hub to the outer diameter of the rim is in particular higher than 1:4.

The hub is in particular configured as an electrically drivable hub motor. It is conceivable for the drive to supply the wheel with the drive energy required in full or in part. It is also conceivable for the electric drive to be used as a generator during braking for recharging an accumulator battery provided internal or external of the hub or to feed it with the energy generated in braking.

Preferably a contact surface is configured between a spoke device and the rim, being annular and in particular approximately line-shaped or in the shape of a narrow ring strip. A narrow line preferably forms a contact ring. The radial contact width is preferably less than 20% of the outer radius of the contact surface. A narrow contact ring offers the considerable advantage that the angle of the spoke relative to the passage opening is adjustable in a wide range. When a spoke nipple is provided at the rim and in particular internal of the rim, then in particular only the spoke passes through the passage opening. In this case the passage opening may simply be referred to as a spoke hole.

In preferred more specific embodiments the spoke nipple is rounded and the contact surface of the passage opening is configured flat at the inner contact surface of the rim base. The spoke nipple which at the contact surface is configured in particular convexly rounded, may assume every angle within a wide angular range at the passage opening that in the contact region is configured flat. This is a considerable advantage over the prior art where the spoke nipple, due to the high spoke tension, has been drawn into the mating shape of the contact surface of the rim eyelet such that the spoke nipple is oriented nearly perpendicular to the rim which may result in a perceptible buckle at the exit from the spoke nipple or in a subsequent bend in the spoke. A flat configuration of the contact surface in the region of the passage opening in conjunction with the corresponding diameter ratios may ensure an optimal orientation of the spoke relative to the rim.

In another preferred configuration the spoke nipple is configured convexly rounded. Then the contact surface at the passage opening of an inner contact surface of the rim base is also configured convexly rounded. Due to the convex rounding of the two surfaces coming into contact the two surfaces virtually roll off each other. In this way it is in turn achieved that only a narrow and in particular annular contact region is present which allows a high degree of flexible orientation of the spoke relative to the rim.

Preferably at least one mounting opening is provided in the rim well for inserting and/or tensioning a spoke device. A corresponding mounting opening is in particular provided in the rim well for each of the passage openings so as to enable inserting a tool from the outside into the hollow portion of the rim for tensioning the spoke nipple.

Preferably the passage opening and the mounting opening can be oriented aligned to one another. The passage opening and the associated mounting opening are in particular disposed slanted relative to a radius of the wheel. The passage opening and the associated mounting opening may be oriented flush to the associated spoke device. Passage openings and mounting openings disposed oblique relative to a radius and approximately flush to one another facilitate, in particular in the case of large spoke exit angles from the rim, ease and reliability of mounting which cannot always be ensured with the conventional, radial arrangement of the passage openings and the mounting openings since the tool-engaging range of the spoke nipple may already be located radially beneath the rim well. Then the mounting and passage openings may be configured slightly oval or elliptical.

In preferred embodiments at least one spoke angle is larger than 7.5 degrees and in particular larger than 10 degrees. In specific configurations the angle may be 12 degrees or more.

Advantageously the spoke nipples are disposed entirely inside the rim or nearly entirely between the rim base and the rim well.

The hub body in particular comprises a hub sleeve provided with hub flanges for attaching the spokes. The ratio of the outer diameter of the hub sleeve to the outer diameter of the rim is in particular higher than 1:6 and preferably higher than 1:4. The ratio of the outer diameter of the hub sleeve to the outer diameter of the rim may be higher than 1:3 and even higher than 1:2 or more.

In all of the configurations the passage opening is preferably provided at a rim eyelet fixedly connected with the rim. While the rim may for example consist of a light metal such as aluminium or magnesium or alloys thereof, the rim eyelet is preferably comprised of a stronger material such as steel. In all of the configurations the wheel is in particular provided as a rear wheel and may comprise a rotor for arranging at least one sprocket or a sprocket assembly and/or a disk brake.

Other advantages and features of the present invention can be taken from the exemplary embodiment which will be described below with reference to the accompanying figures.

These show in:

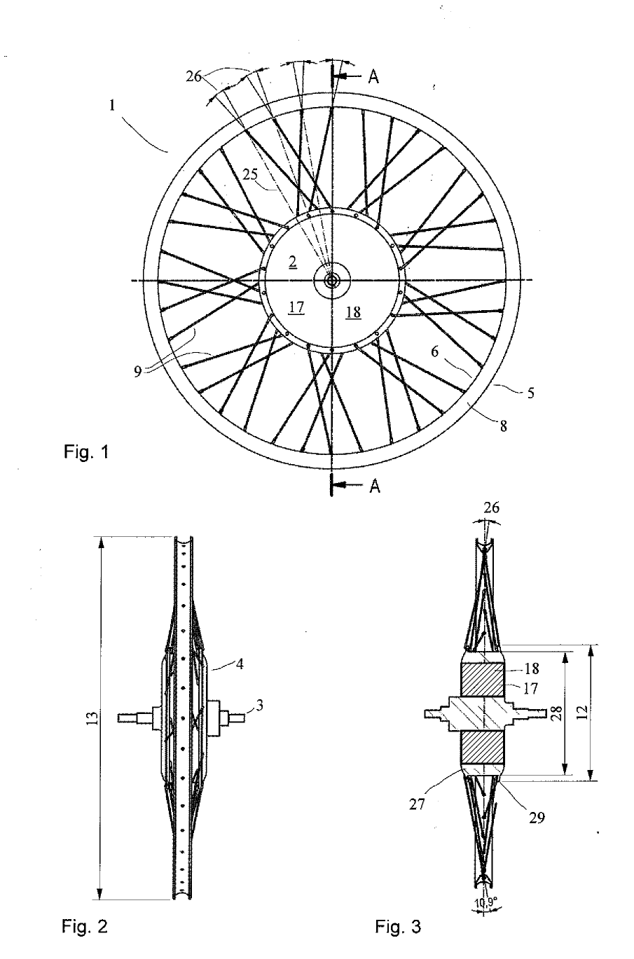

FIG. 1 a side view of an inventive wheel;

FIG. 2 a front view of the wheel according to FIG. 1;

FIG. 3 a schematically illustrated cross-section A-A of the wheel according to FIG. 1;

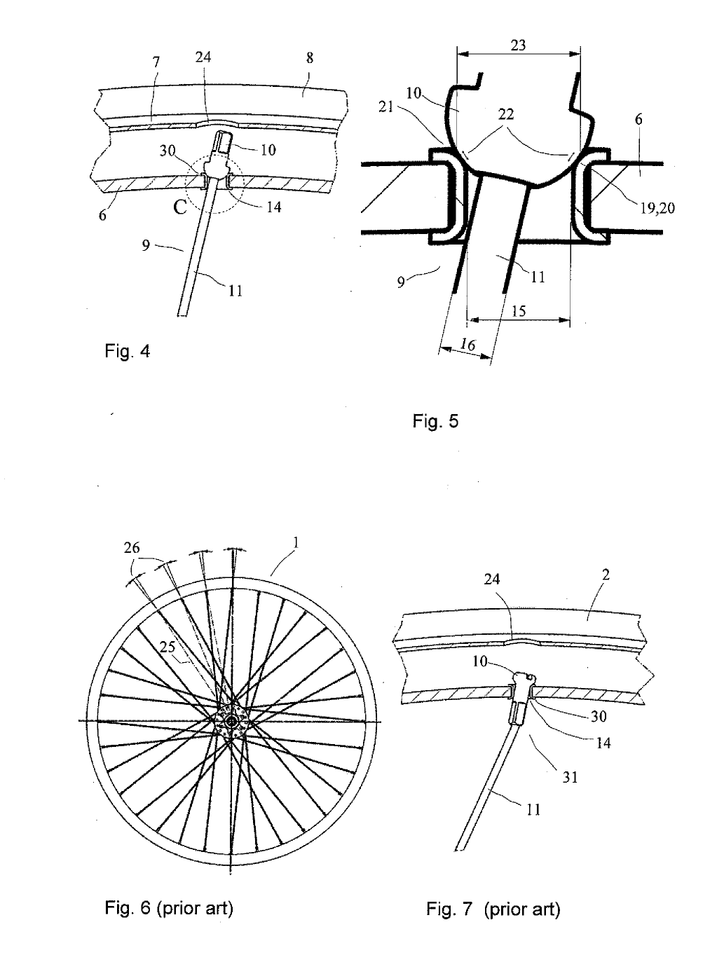

FIG. 4 a schematically enlarged cross-section of a section of the rim;

FIG. 5 the detail C from FIG. 4 in a still further enlarged illustration;

FIG. 6 a conventional prior art wheel; and

FIG. 7 a conventional spoke device with a large spoke angle.

FIGS. 1-5 illustrate an exemplary embodiment of the present invention.

FIG. 1 illustrates an inventive wheel 1 in a side view.

The wheel 1 comprises a hub 2 which is provided with an electric drive 17 or comprises a hub motor 18 which is incorporated in the hub 2.

The hub 2 is connected with the rim 5 in the spoke device 9. In the present embodiment the spoke angles 26 of the spokes 11 to the corresponding radius 25 perpendicular to the rim within the plane of the wheel are approximately 12°.

One can clearly recognize the considerably enlarged outer diameter 12 of the hub 2 (see also FIG. 3). The ratio of the outer diameter 12 of the hub 2 to the outer diameter 13 of the rim 5 is higher than 1:6 and in particular higher than 1:5 and presently even higher than 1:4 and in this case even 1:3. In other configurations the ratio may reach as much as 1:2 or it may be still higher than this value.

In the conventional wheel 1 from the prior art (see FIG. 6) the ratio is typically higher than 1:8 and it may even reach values of 1:10 or the like.

The clearly larger outer hub diameter 12 of the hub 2 of the inventive wheel 1 according to the FIGS. 1-5 is necessary since the electric drive 17, which is in particular configured as a hub motor 18, is incorporated in the hub 2.

The mounting space required therefor results in a larger outer diameter and thus in a larger spoke angle of the spokes 11 which are arranged crossing one another for transmitting torque.

The spokes 11 are typically disposed at hub flanges 29 which extend radially outwardly from the hub sleeve 27 of the hub 2. In the inventive wheel the outer diameter 28 of the hub sleeve 27 is also considerably larger than is usual in the prior art. Hub sleeve outer diameters 28 of 15, 20 or 25 cm may be usual. Again, the ratio of the outer diameter 28 of the hub sleeve 27 to the outer diameter 13 of the rim 5 is higher than 1:6 and in particular higher than 1:4 and it may even be higher than 1:3.

FIG. 4 illustrates in an enlarged view the assembled situation of a spoke device 9 with a spoke 11 and a spoke nipple 10 disposed in the hollow portion between the rim base 6 and the rim well 7.

The passage opening 14 is provided at a rim eyelet 30 that is inserted in a corresponding hole in the rim base 6. While the rim on the whole consists of a comparatively lightweight material and in particular of light metal, the rim eyelet is comprised of a strong material such as steel. It is also conceivable for the rim to be comprised of a fibrous composite material.

As can in particular be taken from the FIG. 5 which shows an enlarged illustration of the passage opening 14 at the rim base 6, the clear inner diameter 15 of the passage opening 14 is considerably larger than the outer diameter 16 of the spoke device in the region of the passage opening 14. In particular the clear inner diameter 15 of the passage opening 14 is more than 50% larger than the outer diameter 16 of the spoke 11 which due to the illustrated arrangement presently illustrates the relevant outer diameter in the region of the passage opening. In the illustrated arrangement the spoke nipple is screwed onto the end of the spoke by means of a nipple head 32 such that the convexly rounded nipple head abuts the contact surface 19 of the rim eyelet 30 while only the spoke 11 of the spoke device 9 extends through the through hole 14.

The rim eyelet 30 comprises a contact surface 19 which is configured as an annular contact surface 20. The annular contact surface 20 has but a very narrow contact width 22 being in contact with the spoke nipple 10. The contact width 22 between the spoke nipple 11 and the rim eyelet 30 is less than 20% of the outer diameter 23 of the contact width. In this way a very narrow contact ring 20 forms so as to allow a largely flexible, angular orientation of the spoke device 9 relative to the rim eyelet 30 or to the passage opening 14. This enables a considerably increased stability and durability of the inventive wheel 1 although the outer hub diameter is large and the spokes are arranged slanted at considerably larger spoke angles.

Unlike the inventive wheel 1 illustrated in the FIGS. 1 to 5 the wheel 1 according to the prior art (FIG. 6) shows considerably smaller spoke angles 26 which are presently between approximately 5 and 6°. The spoke hole diameter is presently less than 75 mm.

FIG. 7 shows a conventional spoke device 9 in which the spoke nipple 10 with its nipple body 33 extends through the passage opening 14 of the rim. The angle of the spoke 11 to the radial orientation is large.

This results in a buckled portion 31 at the exit of the spoke 11 from the spoke nipple 10 since due to the high spoke tension the spoke nipple 10 is drawn into the rim eyelet at its seat. Such a buckled portion 31 leads to a considerably reduced service life and to a considerably higher risk of breakage of the spoke 11.

On the whole the invention allows wheels having considerably larger spoke angles and employing large hubs having large outer hub diameters for electrically assisted wheels which may be operated by muscular force at least in part.

### LIST OF REFERENCE NUMERALS

1 wheel
2 hub
3 hub axle
4 hub body
5 rim
6 rim base
7 rim well
8 rim flanks
9 spoke device
10 spoke nipple
11 spoke
12 outer diameter
13 outer diameter
14 passage opening
15 inner diameter
16 outer diameter
17 electric drive
18 hub motor
19 contact surface
20 annular contact surface
21 contact surface
22 contact width
23 outer radius
24 mounting opening
25 radius
26 spoke angle
27 hub sleeve
28 outer diameter
29 hub flange
30 rim eyelet
31 buckled portion
32 nipple head
33 nipple body

1. Wheel for a vehicle operable at least in part by muscular force and in particular for a bicycle, with at least one auxiliary motor and with a hub comprising a hub axle and a hub body rotatably supported relative to the hub axle, and with a rim having a rim base and a rim well and rim flanks, wherein the rim is connected with the hub through a plurality of spoke devices wherein at least one spoke device comprises at least a spoke nipple and a spoke, and wherein passage openings are provided in the rim base through which the spoke devices extend into the rim, characterized in that an electric drive is provided at the hub as an auxiliary motor, and a ratio of the outer diameter of the hub to the outer diameter of the rim is higher than 1:5, and that the clear inner diameter of a passage opening in the rim base is at least 50% larger than an outer diameter of the spoke device at the passage opening.

2. The wheel according to claim 1, wherein the ratio of the outer diameter of the hub to the outer diameter of the rim is higher than 1:4.

3. The wheel according to claim 1 wherein the hub is configured as an electrically drivable hub motor.

4. The wheel according to claim 1, wherein at least some of the spokes are mounted so as to cross one another.

5. The wheel according to claim 1, wherein the contact surface between a spoke device and the rim is configured line-shaped and in particular annular wherein in particular a radial ring width is less than 20% of the ring diameter of the contact surface.

6. The wheel according to claim 1 wherein the spoke nipple is configured rounded and the contact surface of the passage opening at the inner contact surface of the rim base is configured flat.

7. The wheel according to claim 1, wherein the spoke nipple is configured convexly rounded and the contact surface at the passage opening at the inner contact surface of the rim base is likewise configured convexly rounded.

8. The wheel according to claim 1, wherein at least one mounting opening is provided in the rim well for inserting and/or tensioning a spoke device.

9. The wheel according to claim 1, wherein the passage opening and the mounting opening are disposed at an angle to a radius of the wheel wherein in particular the passage opening and the mounting opening are oriented flush with the associated spoke device.

10. The wheel according to claim 1, wherein at least one spoke angle is larger than 7.5° and in particular larger than 10°.

11. The wheel according to claim 1, wherein the spoke nipples are disposed entirely internal of the rim between the rim base and the rim well.

12. The wheel according to claim 1, wherein the hub body comprises a hub sleeve with hub flanges for the attachment of the spokes.

13. The wheel according to claim 1, wherein the ratio of the outer diameter of the hub sleeve to the outer diameter of the rim is less than 1:6 and in particular less than 1:4.

14. The wheel according to claim 1, wherein the passage opening is provided at a rim eyelet fixedly connected with the rim.

15. The wheel according to claim 1, wherein a rotor is provided for the arrangement of at least one sprocket or a sprocket assembly and/or a disk brake.
